(19) United States
(12) Patent Application Publication
(10) Pub. No.: US 2005/0081437 A1
(43) Pub. Date: Apr. 21, 2005

(54) Modular element for forming lawn or flowerbed borders or the like

(75) Inventor: Udo Heinemann, Wunstorf (DE)

Correspondence Address: ALIX YALE & RISTAS LLP, 750 MAIN STREET, SUITE 1400, HARTFORD, CT, 06103, US

(73) Assignee: Marley Deutschland GmbH

(21) Appl. No.: 10/919,578

(22) Filed: Aug. 17, 2004

Related U.S. Application Data
(63) Continuation of application No. PCT/EP03/01806, filed on Feb. 21, 2003.

(30) Foreign Application Priority Data
Feb. 21, 2002 (DE) 202 02 732.5
Jan. 10, 2003 (DE) 203 00 349.7

(51) Int. Cl. A01G 1/00

(52) U.S. Cl. 47/33

(57) ABSTRACT

A modular element or a so-called edging stone for forming a lawn or flowerbed border, consisting of a lower part 1, 51, which forms a continuous channel 11 for receiving a hose and/or cable, and a lid 3, 53 that is attached in a snap-on or hinged fashion to the lower part, which when the modular element is embedded so as to be flush with the surface forms a flat top that can be walked on or driven on. The lid and lower part are concavely curved on one end and convexly with the same radius on the other end, so that contiguous modular elements can be laid down at a desired angle to one another without forming a gap, in order to form curved lawn or flowerbed borders. Within the modular element, built-in parts or connectors can be arranged, such as for example a luminous element 73, an electrical socket 85, or a water-hose hook-up 81, 82.

### CROSS REFERENCE TO RELATED APPLICATION

This is a continuation of International Application No. PCT/EP03/01806 filed Feb. 21, 2003.

### BACKGROUND OF THE INVENTION

The invention relates to a modular element that can be used especially for lawn or flowerbed borders. Other uses are likewise possible, such as for example for the purpose of marking out or differentiating traffic areas. For such modular elements the term “edging stone” is frequently used, as it will also be in the following specification, but this term does not signify any limitation with respect to the material of construction. The modular element or edging stone can be comprised of any desired material, such as for example concrete, ceramic, or plastic. The edging stone in accordance with the invention is preferably made from plastic by means of an injection molding process.

Known to the art and available on the market are lawn edging stones made of concrete, which are embedded in the ground and laid flush with its surface in such a way that they do not hinder mowing of the lawn. They are convexly rounded on one end and concavely on the other end, so that they can be laid down at an angle to one another in order to permit the laying of lawn or flowerbed borders that are not in a straight line. Lawn edging stones of this sort are described also in EP 1 081 314 A1.

Known to the art from EP 0 721 295 B1, EP 0 716 803 A1, and WO 00/04758 are lawn or flowerbed edging stones in the form of boxes that are open from below and that can be connected together by means of coupling elements. According to EP 0 721 295 B1, a chain of lights can be threaded through the interior of the box-shaped stones and through their tubular connecting means, which can illuminate from within such edging stones, which are constructed so as to be transparent. The threading in of such a cable is troublesome, and it is not possible to subsequently gain access to the cable along the laid lawn or flowerbed border.

Known to the art from U.S. Pat. No. 5,535,545 A is a lawn or flowerbed border comprising plate elements that taper to a point below, which can be driven into the earth and which form on their top side a concave support for a garden hose, and comprising also a U-shaped covering that can be secured to the plates. This bordering system cannot be laid flush with the surface and cannot be walked on or driven on with a lawnmower. Also it is not possible, in particular because of the shape of the coverings, to arrange contiguous elements at an angle to one another and thus to make a curved border.

### SUMMARY OF THE INVENTION

The invention is based on the object of providing a modular element in the form of an edging stone with which it is possible to make lawn or flowerbed borders that can be laid flush with the ground surface, can be walked or driven on, and also can take any desired curved course, and that has the additional function that a lawn or flowerbed border laid down from abutting edging stones has a continuous cable or hose channel for receiving an electrical cable and/or a watering hose and/or any other such line.

Briefly stated, the invention in one preferred form is a modular element for use as an edging stone for lawn or flowerbed borders, wherein the modular element is in the form of an elongated block that when embedded in the earth, can be laid flush with its surface and has a flat top that can be walked on, and wherein the element has at its one end, a convex outward rounding, and its other end, a concave inward rounding, such that contiguous modular elements can be laid down at a desired angle to one another without forming a gap at their faces. The modular element comprises a lower port that forms a channel which is continuous in the longitudinal direction, and is open at both faces, and a lid that is set upon the lower part, wherein the channel outlet at the convexly rounded end of the modular element is bounded in width by inwardly projecting curve wall parts in such a way that it connects up without any lateral gaps to the mouth of the channel of the concave end of the adjointingly arranged modular element.

The lid may be detachably attached to the lower part by means of a snap-on connection. The lid may be hinged so that it can be raised up and arrested in the raised position. At least one drain opening may be provided in a floor wall of the lower part. A luminous element may be arranged on the lower part, and the lid constructed to be permeable to light. A plug-in termination for the connection of a hose or an electrical socket is also arranged within the modular element.

One end of the modular element may have a hook shaped coupling projection, and the other end a receiving structure such that the two contiguous modular parts can be coupled together. The lower area of the modular element has a floor which forms a supporting surface and supporting shoulders are provided at a distance above the floor.

Another object involves specifying an edging stone with a construction that is especially well suited to being manufactured from plastic in an injection-molding process.

### BRIEF DESCRIPTION OF THE DRAWINGS

One embodiment of the invention is explained in more detail on the basis of the drawings. These show:

FIG. 1 an edging stone in accordance with the invention in a perspective view,

FIG. 2 a cross section through the edging stone of FIG. 1,

FIG. 3 a view of the edging stone of FIG. 1 from below,

FIG. 4 two edging stones abutting one another in a straight line with their lids lifted off,

FIG. 5 in a three-quarter view from above, two edging stones abutting one another at an angle, with their lids removed,

FIG. 6 in a perspective view from below, two edging stones without lids and abutting one another in a straight line,

FIG. 7 a longitudinal section along the longitudinal median plane of the contiguous edging stones shown in FIG. 6,

FIG. 8 in a perspective view, two edging stones according to a different embodiment of the invention,

FIGS. 9 and 10 the edging stones according to FIG. 8 in longitudinal section and in a view from below respectively,

FIG. 11 a cross section of the edging stone corresponding to the line x-x of FIG. 10,

FIG. 12 in perspective, an edging stone that can be combined with the edging stone according to FIG. 8 to 11, but having a functionally different construction,

FIG. 13 in accordance with the invention, an arrangement of strung-together edging stones having functionally different constructions,

FIGS. 14 to 17 each show in perspective the details of the variously constructed edging elements that are used in FIG. 13.

### DETAILED DESCRIPTION OF THE PREFERRED EMBODIMENTS

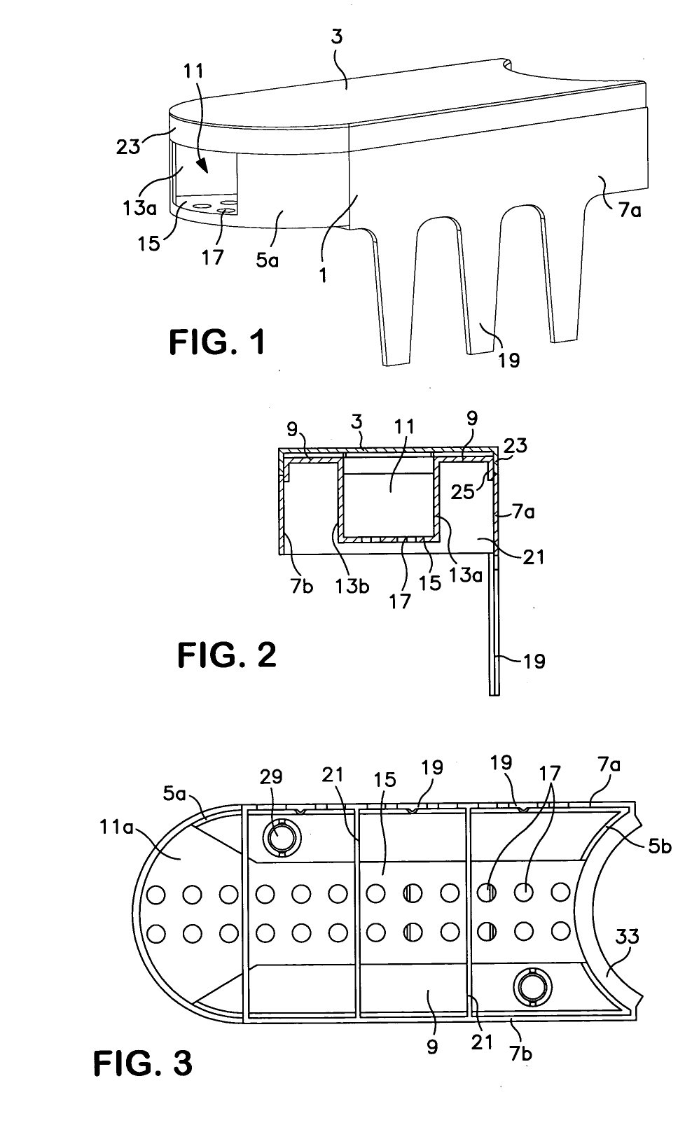

The modular element for use as an edging stone that is represented in FIGS. 1 to 3 comprises two parts, a lower part 1 and an upper part or lid 3. As a whole, this edging stone has the form of an elongated block whose two ends are bounded by face walls 5a, 5b that are curved in a circular-arc fashion, with face wall 5a being convexly curved on one end and the other face wall 5b being concavely curved with the same radius. As can be seen in FIG. 2, the lower part 1 is a thin-walled injection-molded part with two parallel side walls 7a, 7b and a top wall 8, 9, within which part a channel 11 is constructed, open at the top, with side walls 13a, 13b and a floor wall 15. A number of drain openings 17 are constructed in the floor wall 15. Downwardly directed tongues 19 are molded onto the one side wall 7a of the lower part 1 as an extension, for purposes of the better anchoring of the edging stone in the earth. The lower part 1 is braced by a number of bracing walls 21 running in a transverse direction between the side walls 7a, 7b.

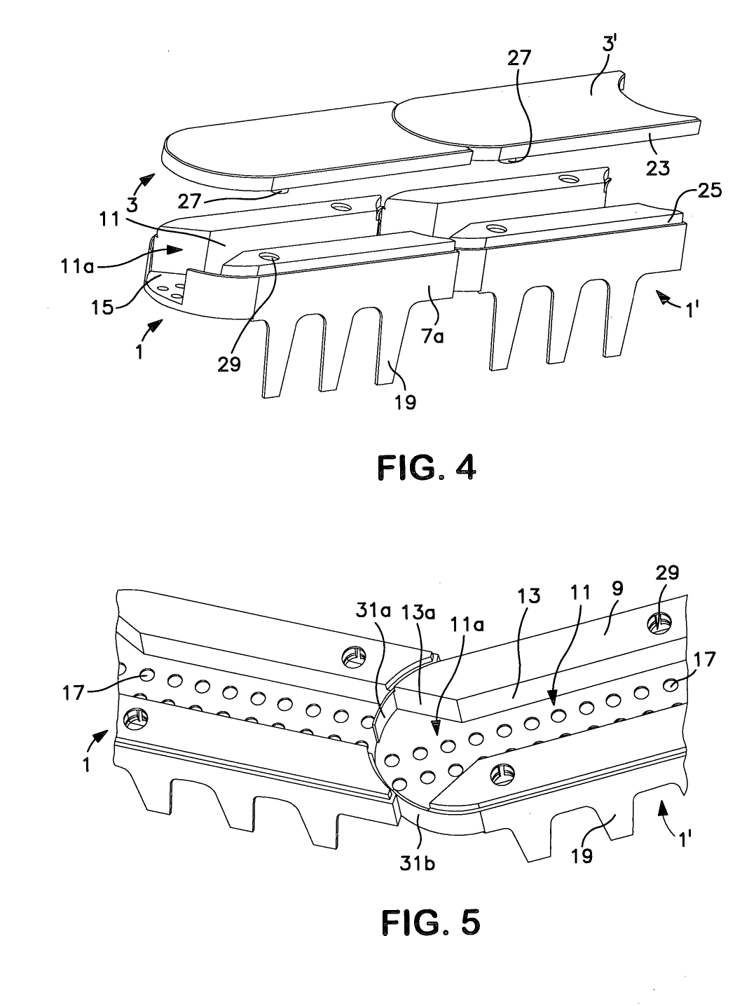

The lid 3 is a flat plate whose shape corresponds to the top-view shape of the lower part 1, with its face sides being concavely or convexly curved, and this lid is formed with a downwardly directed web 22 around its periphery with such web being received and centered by a step-shaped offset 25 of the lower part. In addition there are pegs 27 (FIG. 4) projecting along the underside of the lid, which in the manner of a snap fastener can engage in corresponding receiver openings 29 of the lower part, in order to hold the lid 3 onto the lower part 1 by a snap fit. But this snap fit can also be achieved by the encircling band 23 alone.

In the lower part 1, the channel 11, which is open at the top and is bounded by the floor wall 15 and the two side walls 13a, 13b, is also open towards the two ends of the lower part 1. At the convexly curved end the channel 11 has an outlet 11 a that enlarges in funnel-shaped fashion, with this outlet being bounded by correspondingly angled regions 13c of its side walls 13. (see also FIG. 5). The aperture angle of the enlargement of the channel 11 can amount to 30°, for example. The funnel-shaped enlargement of the channel 11 permits the full width of the channel cross section to be retained even when abutting edging stones are laid at an angle to one another.

As FIG. 5 shows in particular, the side regions of the enlargement 11 a of the channel 11 are closed off by thin face-wall parts 31a, 31b. When two edging stones are laid at an angle to one another, then the face-wall part 31b along the outside of the angle keeps the channel 11 from becoming laterally open at this location. The thin face-wall parts 31a, 31b can be broken away. The face-wall part 31a lying along the inside of the angle is always broken away, so as to open up the full channel cross section.

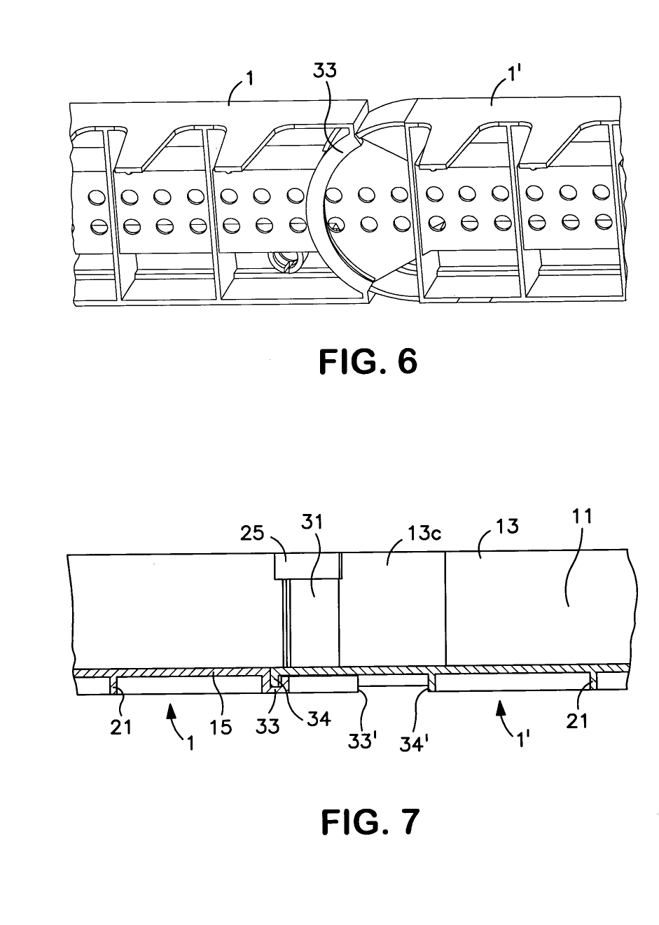

As is shown in particular in FIGS. 6 and 7, the lower part 1 of the edging stone has on its concave end a projecting hook-shaped supporting flange 33, which forms a groove that is open at the top. Molded on the convex end of the lower part 1 of the edging stone is a web 34 in the shape of a semi-circle and directed downward. When the edging stones are laid, the groove formed by the hook-shaped flange 33 receives the web 34 of the next adjoining edging stone 1′, so that the two edging stones are coupled together in such a way as to resist being pulled apart. The complementary circular-arc shapes of groove 33 and web 34 permit an optional angling of the edging stones 1, 1′ with respect to one another. When the stones 1 and 1′ are laid at an angle to one another, the end 33′ of the hook-shaped flange 33 may come to strike against the step 34′ of the web 34, which thus determines the maximum displacement angle between the stones 1 and 1′.

When a number of edging stones in accordance with the represented embodiment are laid down so as to abut one another either in a straight line or at an angle, one obtains a lawn or flowerbed border with a continuous channel for receiving an electrical cable and/or a watering hose and/or any other such line. The cable and/or the hose that is laid within the channel can stay there permanently, namely throughout the year. The digging of a special ditch for laying such a hose or cable is not necessary. By lifting off the lid 3 the cable or the hose is accessible at any time. In particular, by lifting off the appropriate lid it is possible to selectively gain access to the end of the hose or cable in order to connect up there, for example, a sprinkler or an electrical device, e.g. an electric lawnmower.

In a further embodiment of the invention, one or more of the edging stones can be equipped with a special lid, which itself is equipped with a receptacle for an electrical connection or for a water connection (not represented in the drawings). In such a case it is possible to connect up, e.g. a sprinkler or an electric lawnmower without needing to raise the lid.

It is also possible to construct the lid 3 to be transparent and to accommodate within the channel 11 a lamp connected up to the electrical cable, in order to illuminate the lawn or flowerbed border.

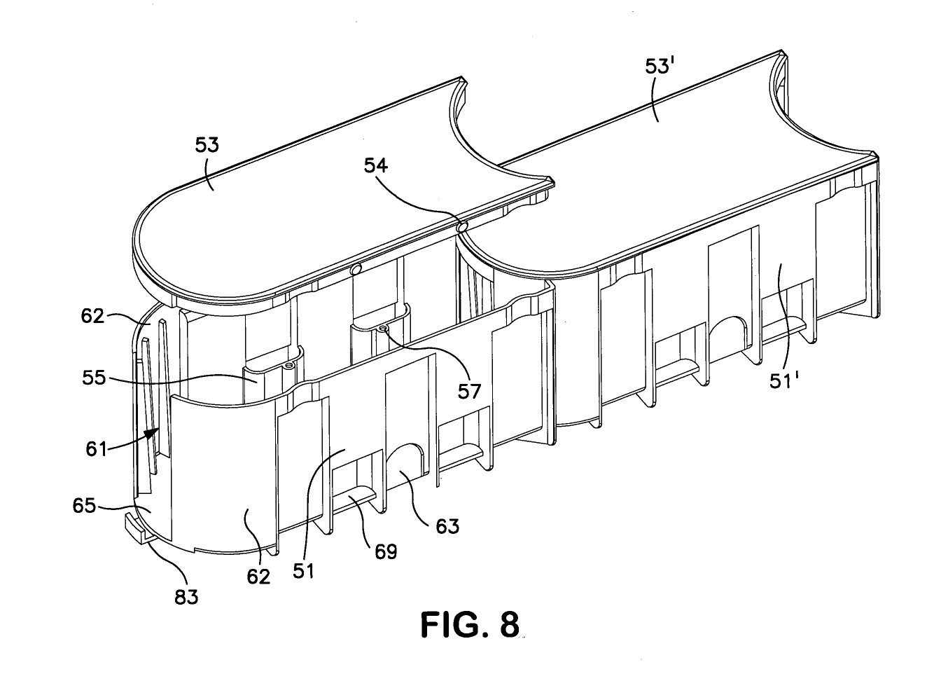

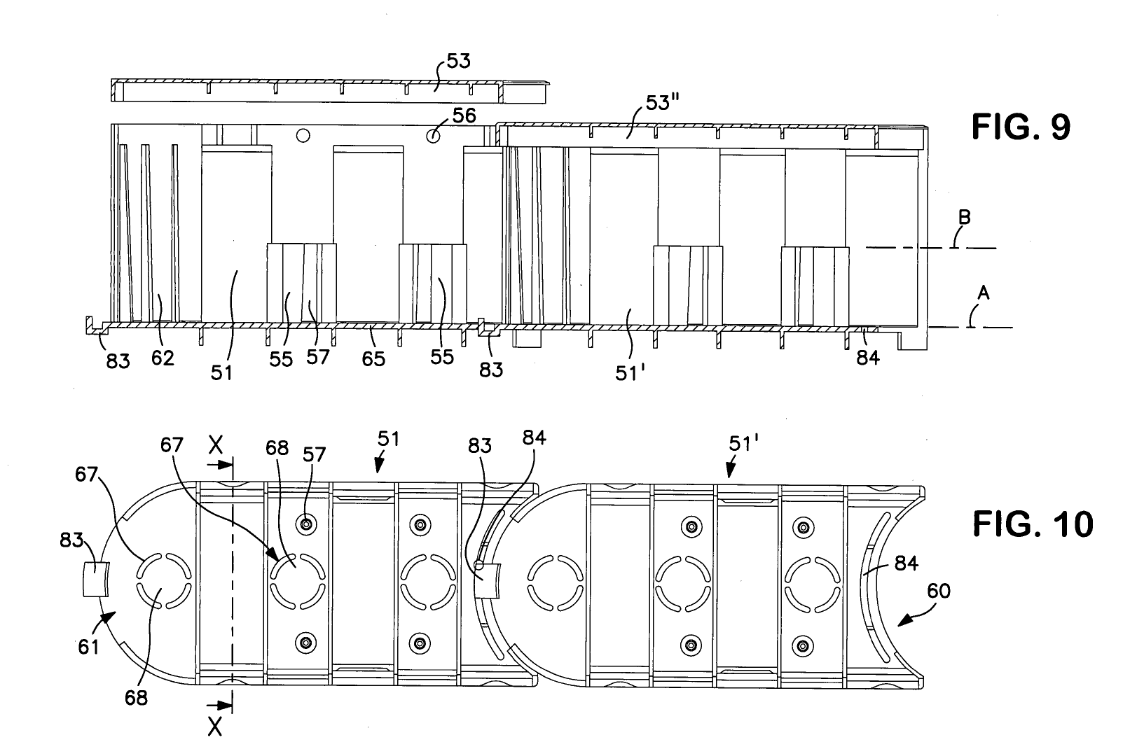

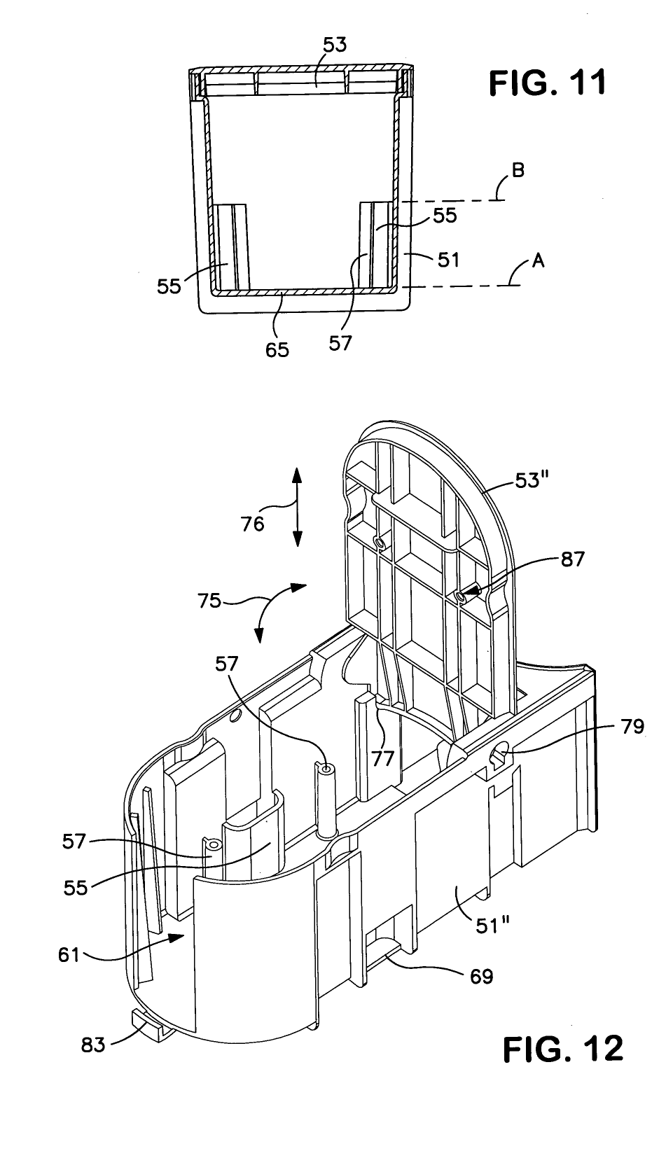

FIGS. 8 to 17 show edging stones in accordance with a second embodiment of the invention, whose geometry differs from the embodiment according to FIGS. 1 to 7. FIGS. 8, 9, and 10 show two edging stones coupled together, which have respectively a lower part 51, 51′ and an upper part or lid 53, 53′. Both the lower part and the lid are concavely curved at one end and convexly with the same radius at the other end. For purposes of a snap-on attachment to the lower part 51, the lid 53 has lateral projections 54, which can engage in recesses 56 (FIG. 9) of the lower part. The lower part 51 or 51′ is greater in height than that of the embodiment according to FIGS. 1 to 7, and it has a low-lying floor 65 that defines a lower system plane A, on which for example a continuous cable or a water hose can be put down. Openings 60, 61 on the faces of the concavely and convexly curved ends of the edging stones create a continuous channel for the laying of the cable or hose. At the convex end the opening 61 is bounded in its width by curved, inwardly-projecting wall parts 62, against which can tightly fit the vertical edges of the side walls of an element connected up to it at an angle.

Molded onto the side walls of the lower part 51 are pedestals 55 that project inwards and that, starting at the floor 65, extend over a portion of the overall height of the lower part 51 and by way of their upper ends form supporting shoulders that define a second, upper system plane B. These shoulders formed by the pedestals 55 can have mounted on them in the second system plane B certain insert elements, such as for example a shelf, an electrical distribution box, or the like. Furthermore, the supporting pedestals 55 have associated with them screw holders 57 for receiving self-threading attachment screws, by means of which the add-on elements can be attached.

Furthermore, along the side walls of the lower part 51 are anchoring webs 69 for anchoring the edging stone in the ground, as well as knock-out wall regions 63 for the purpose of creating an opening for the lateral inserting of a cable or hose. On the convex face is a hook 83, which in accordance with FIG. 10 can engage from below in an arc-shaped slot that is constructed on the floor of an adjoining edging stone at its concave end. In this way contiguous edging stones can be coupled together in a swivel arrangement, whereby the swivel angle can amount to about 30° in both directions.

As can be seen in FIG. 10, in the floor 65 of the lower part 51 or 51′ are also arc-shaped slot-type openings 67 that are constructed in such a way that on the one hand they can serve as drainage openings for the runoff of water, and on the other hand they enclose a knock-out floor region 68, which when knocked out permit an opening to be created for introducing a cable or hose from below. Furthermore, also visible in FIG. 10 are the lower exit holes of the screw holders 57 used for the introducing of attachment screws.

The embodiment of an edging stone shown in FIG. 12 differs from the embodiment according to FIGS. 8 to 11 mainly in that the upper part or lid 53″ is pivotally hinged on the lower part 51″. Serving to accomplish this are laterally projecting pivot pins (not shown) in the lid 53″, which engage in pivot openings 79 of the lower part 51″. The lid 53″ can be swung up by 90° relatively to the lower part, in a manner corresponding to the arrow 75. Each pivot opening 79 has a non-round downward extension, so that the lid 53 can be moved downward by a movement corresponding to the arrow 76, in order to lock in place behind an arresting shoulder 77, which serves to arrest the lid 53′ in the vertical, swung-up position. For purposes of releasing this arrested state the lid 53′ can be lifted upwards corresponding to the arrow 76. The lower part 51′ according to FIG. 12 likewise has supporting pedestals 55 that define an upper system plane, as well as screw holders 57, which in this case are constructed to be separate from the supporting pedestals 55, for the reception of attachment screws. The lid 53″ also sustains molded-on screw holders 87.

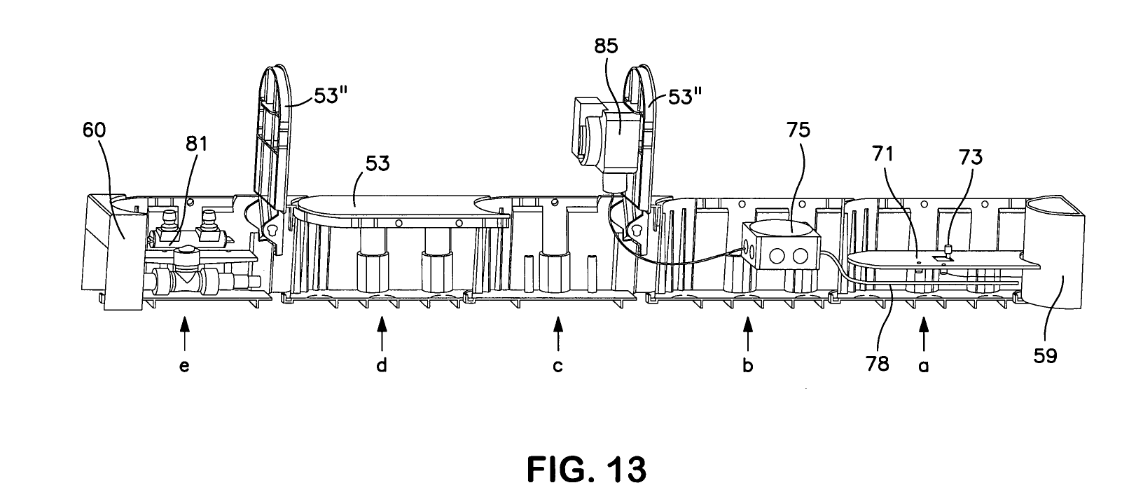

FIG. 13 illustrates how edging elements according to FIG. 8 or FIG. 12 can be laid in combination with one another to form a continuous lawn or flowerbed edging, whereby the various elements can be equipped with differing functions. The edging-stone elements strung together according to FIG. 13 are designated from right to left by the letters a, b, c, d, e. On the right end this string is terminated by a convex termination piece 59 and on the left by a concave termination piece 60. Between the termination pieces 59, 60 the strung-together elements form at their lower or floor plane surface a continuous channel for the laying of a water-line hose 76 (in FIG. 13 indicated schematically by a series of vertical, black dashes) and/or an electrical cable 78.

The right-hand element a in FIG. 13, which is also represented in FIG. 15, has essentially the construction represented in FIG. 8, but here it has been constructed to be an illuminating element by the insertion of an intermediate floor 71 that rests on the supporting pedestals 55 of the lower part 51. The intermediate floor 71 supports an electrical luminous element 73 and is constructed as a reflector for the same. The lid 53 for the edging element a (this lid not shown in FIG. 13) is constructed to be correspondingly permeable to light.

The element b second to the right in FIG. 13 likewise has the design of a basic element as represented in FIG. 8. An electrical distribution box 75 is placed on its supporting pedestal 55 in the upper system plane and is attached there by means of screws.

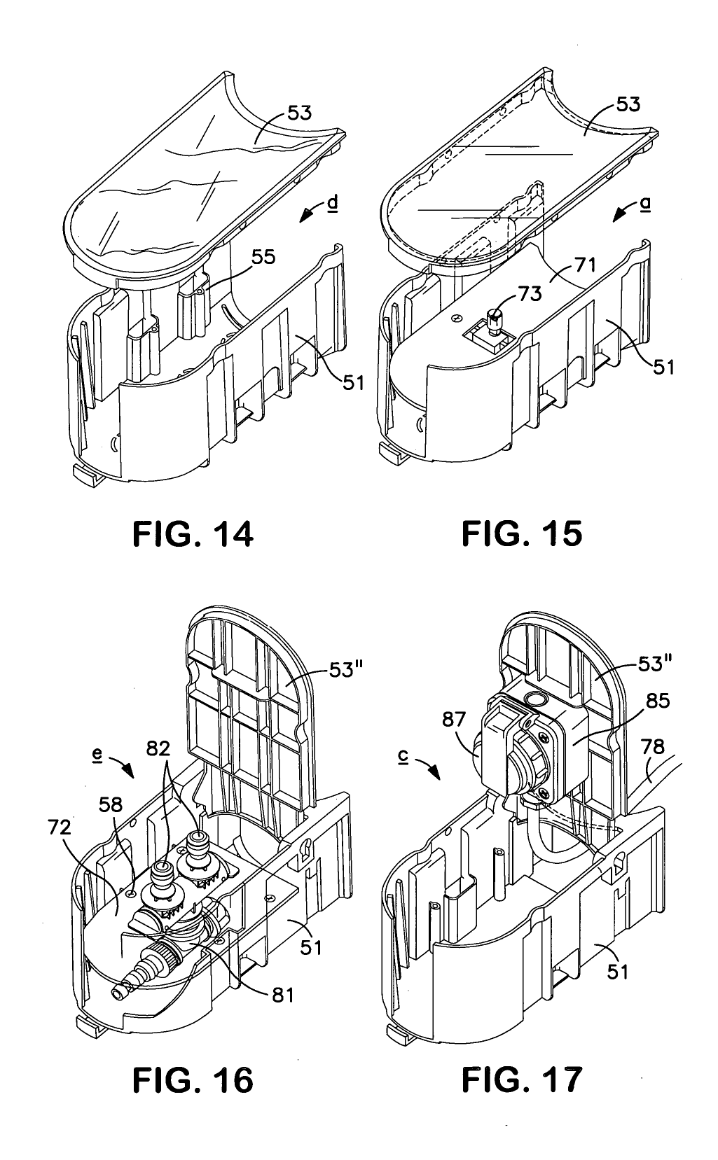

The third element c in FIG. 13, which is additionally shown in FIG. 17, has in principle the design shown in FIG. 12 with a hinged lid 53″. Attached to the inside of this lid 53″ is an electrical socket 85 with a waterproof cover 86, which when the lid 53″ is raised can serve as the connecting point for the power-supply cord of an electrical device, for example a lawnmower. The fourth element d in FIG. 13 is an empty or basic element and has the design represented in FIG. 8 as well as in FIG. 14. The snap-on lid 53 shown with this element d should also be imagined for the elements a and b in FIG. 13.

The left-hand element e in FIG. 13, also represented in FIG. 16, has again the basic form represented in FIG. 12, with a hinged lid 53″. Placed inside the lower part 51 of this element e is an intermediate floor 72 supported on the support pedestals 55 (FIG. 12) and attached by means of screws 58 to the screw bases 57, with this floor sustaining a water-supply hook-up 81 that can be coupled with the hose 76, such as for example two coupling nipples 82 for connecting up a garden hose and/or a sprinkler.

The lids 3 or 53 of all the elements can have on their upper side a relieved surface structure in order to make them skid-resistant and/or, when given a suitable coloration, so that they can simulate the appearance of natural stone.

1. Modular element for use as an edging stone for lawn or flowerbed borders or the like, in the form of an elongated block that when embedded in the earth can be laid flush with its surface, and that has a flat top that can be walked on, wherein the modular element has at its one end a convex outward rounding and at its other end a concave inward rounding complementary to this, such that contiguous modular elements can be laid down at a desired angle to one another without forming a gap at their faces,
characterized such that the modular element comprises a lower part that forms a channel which is continuous in the longitudinal direction and is open at both faces, and a lid that is set upon the lower part,
wherein the outlet of said channel at the convexly rounded end of the modular element is bounded in width by inwardly projecting curved wall parts in such a way that it connects up without any lateral gaps to the mouth of the channel at the concave end of an adjoiningly arranged modular element.

2. Modular element based on claim 1, characterized such that the lid is detachably attached to the lower part by means of a snap-on connection.

3. Modular element based on claim 1, characterized such that the lid is hinged on the lower part in such a way that it can be raised up.

4. Modular element based on claim 3, characterized such that the lid can be arrested in the raised position.

5. Modular element based on claim 1, characterized such that at least one drain opening is provided in a floor wall of the lower part.

6. Modular element based on claim 1, characterized such that a luminous element is arranged in the lower part and the lid is constructed to be permeable to light.

7. Modular element based on claim 1, characterized such that a plug-in termination for the connecting up of a hose or else an electrical socket is arranged within the modular element.

8. Modular element based on claim 1, characterized such that it has at its one end a hook-shaped coupling projection and at the other end a receiving means which is suited to the receiving of such a coupling projection, such that two contiguous modular parts can be coupled together in such a way as to resist being pulled apart, by means of an interlocking of the coupling projection and the receiving means, wherein the coupling projection and receiving means are arranged in the form of circular arcs in such a way that the modular parts can be coupled together at a desired angle.

9. Modular element based on claim 1, characterized such that in the lower area it has a floor, which forms a supporting surface, and such that in the interior of the lower part supporting shoulders are provided at a distance above the floor.

10. A system comprising a plurality of modular elements for forming a lawn or flowerbed border, each said modular element comprising a lower part that forms a channel which is continuous in the longitudinal direction and is open at both faces, and a lid that is set upon the lower part, wherein the channel outlet of the channel at the convexly rounded end of the modular element is bounded in width by inwardly projecting curved wall parts in such a way that it connects up without any lateral gaps to the mouth of the channel at the concave end of an adjoiningly arranged modular element, characterized such that the system includes a plurality of differently equipped modular elements that form a single continuous channel, and at least one of the following modular elements comprises a structure selected from the group consisting of:
a built-in lamp and a lid permeable to light;
an electrical socket; and
a hose hook-up.

11. The system of claim 10, characterized in that a modular element has a lid detachably attached to the lower part by means of a snap-on connection.

12. The system of claim 10, characterized in that a modular element has a lid hinged on a lower part of the element.

13. The system of claim 10, characterized in that a modular element has a lower part with a floor wall provided with at least one drain opening.

14. Modular element based on claim 2, characterized such that at least one drain opening is provided in a floor wall of the lower part.

15. Modular element based on claim 3, characterized such that at least one drain opening is provided in the floor wall of the lower part.

16. Modular element based on claim 4, characterized such that at least one drain opening is provided in the floor wall of the lower part.

17. Modular element based on claim 2, characterized such that a luminous element is arranged in the lower part and the lid is constructed to be permeable to light.

18. Modular element based on claim 3, characterized such that a luminous element is arranged in the lower part and the lid is constructed to be permeable to light.

19. Modular element based on claim 4, characterized such that a luminous element is arranged in the lower part and the lid is constructed to be permeable to light.

20. Modular element based on claim 5, characterized such that a luminous element is arranged in the lower part and the lid is constructed to be permeable to light.
